(19) United States
(12) Patent Application Publication
(10) Pub. No.: US 2007/0234197 A1
(43) Pub. Date: Oct. 4, 2007

(54) Universal form filler software

(76) Inventor: Frederick Njuki, Houston, TX (US)

Correspondence Address: Frederick Njuki, 10800 Clay Road, Apt 9204, Houston, TX, 77041, US

(21) Appl. No.: 11/726,473

(22) Filed: Mar. 22, 2007

Related U.S. Application Data
(60) Provisional application No. 60/744,179, filed on Apr. 3, 2006.

(51) Int. Cl. G06F 17/00; G06F 17/30; H04L 9/32

(52) U.S. Cl. 715/507; 715/505; 726/27

(57) ABSTRACT

A software program for completing electronic forms online, on a local network or on a local computer is described in this invention. This software can function as a plug-in for popular word-processors, databases, spreadsheets or PDF readers.

### STATEMENT OF RELATED CASES

This application claims the benefit of U.S. Provisional Application No. 60/744,179, filed Apr. 3rd, 2006.

### DESCRIPTION

This invention describes a software program that simplifies completion of forms using data elements stored in an encrypted password protected file on the hard drive of a user's computer or any portable media such as a USB disk, CD-ROM, local or remote server. Substantial time is required to complete various forms ranging from application for a birth certificate, through life events such as applying for college, employment, etc. For example, it takes on average 2-3 hours to complete the application forms for a medical license with a State Board of Medicine, assuming you have all the necessary the information in front of you, at the time of completion. Most of the information required on most of these forms is repetitive. Often, you have to complete more than one copy of the same form which lends itself to automation using this new software plug-in. An online application completed with software plug-in can take a few seconds to populate by uploading the datasets, and only about 15 minutes reviewing for accuracy afterwards.

This program can function independently, or as a plug-in to popular word-processor or document reader programs. The data elements used to populate the online forms are stored by the program locally or on removable media. The data elements will include common demographic information we use to complete application forms whether for employment applications, life insurance applications, financing such as mortgage applications. Additional datasets can also be narrowed down to employment specific datasets, whereby for instance, a physician applying for credentialing will have, in addition to the basic datasets, a unique physician dataset including residency training, malpractice history, disciplinary actions history and details of state medical board licenses if any. For date-fields that have an expiry date, the program will have the ability to warn the user of an expired field, so the user can update this accordingly. The program can function as a plug-in to existing popular word-processing software, or PDF document readers. The documents that comprise the application forms will have smart-tags in each entry box, and the user will be able to auto-fill the form either downloaded, or online if it is on a secure website. An update to existing word processor and PDF forms will be needed to incorporate the smart-tags, while maintaining backward compatibility to older word-processors and PDF readers. This invention in summary describes a software program for completing electronic forms is described in this invention. It is composed of a password protected file residing on a user's computer with datasets matching smart-tags on electronic forms in a word processor or PDF document. This invention can expedite the completion of electronic form. The software has built-in login to remind the user of expiry dates of date fields.

What is claimed is:

1. This invention claims a method of automatically completing electronic forms using data stored in an encrypted password protected file kept by user on a local computer, portable media or secure remote server.

2. This invention claims a method of entering and saving data in a secure encrypted file that can be read by word-processors or PDF document readers on a local computer or a remote computer over a network as claimed in 1.

3. This invention claims a method of reminding user of date sensitive fields that need updating as claimed in 1.

4. This invention claims a method of embedding smart-tags in a form to be populated from the encrypted file described in 1.

5. This invention claims a method of alerting user of expired date fields in the database.

6. This invention claims a method of incorporating the software in popular word processors, databases, spreadsheets or PDF readers as a plug-in.
